(19) United States
(12) Patent Application Publication
(10) Pub. No.: US 2016/0036059 A1
(43) Pub. Date: Feb. 4, 2016

(54) CURRENT COLLECTOR ALSO SERVING AS ELECTRODE FOR BATTERY, AND BATTERY INCLUDING THE SAME

(71) Applicant: HONDA MOTOR CO., LTD., Tokyo (JP)

(72) Inventors: Toshio Tokune, Wako-shi (JP); Hidefumi Nikawa, Wako-shi (JP); Natsuo Nakamura, Wako-shi (JP); Takahiro Komori, Wako-shi (JP)

(21) Appl. No.: 14/809,536

(22) Filed: Jul. 27, 2015

(30) Foreign Application Priority Data
Jul. 30, 2014 (JP) 2014-155356

(51) Int. Cl. H01M 4/80; H01M 4/66

(52) U.S. Cl. CPC H01M 4/80; H01M 4/664

(57) ABSTRACT

A current collector also serving as an electrode for a battery includes a three-dimensional fiber composite in which a plurality of conductors are disposed in a three-dimensional void of a three-dimensional fiber assembly skeleton, the three-dimensional fiber assembly skeleton being formed by intersecting and assembling a plurality of irregular shaped carbon nano-tubes. An active material that is carried on the carbon nano-tubes or an active material that is carried on the conductors is accommodated in the three-dimensional void inside the three-dimensional fiber composite, and the three-dimensional fiber composite is shaped in a sheet shape.

### CROSS-REFERENCE TO RELATED APPLICATION

Priority is claimed on Japanese Patent Application No. 2014-155356, filed on Jul. 30, 2014, the contents of which are incorporated herein by reference.

### BACKGROUND OF THE INVENTION

1. Field of the Invention

The present invention relates to a current collector also serving as an electrode for a battery, and a battery including the same.

2. Description of Related Art

In a battery of the related art, a mixture layer, which contains an active material, is plated on a metal current collector and is used as an electrode. In a case of a high-output battery, the following efforts and the like have been made. The electrode thickness is made to be small so as to lower the internal resistance of the battery, and a positive electrode and negative electrode additive (vapor grown carbon fiber: VGCF, product name, manufactured by Showa Denko K.K.), and a conductive auxiliary agent such as carbon and metal fine particles are added.

However, in the case of the former, a weight and volume ratio occupied by the current collector increases, and thus there is a limit to realization of a high output while maintaining a capacity necessary for an electronic device.

In addition, in the case of the latter, in addition to the weight of the current collector, it is necessary for approximately 10 wt. % of the conductive auxiliary agent to be added so as to form a conductive path. Accordingly, it becomes disadvantageous in proportion to the addition from the viewpoint of an output.

On the other hand, from the viewpoint of using a carbon nano-tube as a current collector, there is known a technology in which a sheet configured of a carbon nano-tube is used as the current collector in an electrode sheet for a battery which is obtained by forming a mixture layer containing an active material on a surface of a strip-shaped current collector (refer to Japanese Unexamined Patent Application, First Publication No. 2011-198600).

As the technology of using the carbon nano-tube in a secondary battery, there is known a lithium ion secondary battery in which a composite carrier is constituted by carrying a metal composite oxide on the carbon nano-tube having a G/D ratio of 2 to 20, and a length of 10 μm or greater, and the composite carrier is used as a positive electrode active material (refer to Japanese Unexamined Patent Application, First Publication No. 2013-118126).

In addition, there is disclosed a technology in which so as to generate a composite material of a metal compound and fibrous carbon such as a carbon nano-tube, a reaction is allowed to occur by applying a shear stress and a centrifugal force to a solution containing the metal compound and the fibrous carbon, thereby generating the composite material of the metal compound and the fibrous carbon. A mixed solution is generated from the composite material, the mixed solution is suction-filtered and vacuum-dried, and the resultant material is molded in the shape of paper to manufacture a sheet-shaped composite (refer to Japanese Unexamined Patent Application, First Publication No. 2013-098265). Japanese Unexamined Patent Application, First Publication No. 2013-098265 discloses a technology of using the sheet-shaped composite as an electrode for a battery.

In addition, with regard to a negative electrode for a lithium ion secondary battery, there is known a technology in which a carbon nano-tube source containing a plurality of carbon nano-tubes and an active material are dispersed in a solvent, dispersion is performed with ultrasonic waves, and the carbon nano-tubes and the active material are separated from the solvent to manufacture the negative electrode for the lithium ion secondary battery (refer to United States patent application, Publication No. 2013/0106026).

### SUMMARY OF THE INVENTION

The structure disclosed in Japanese Unexamined Patent Application, First Publication No. 2011-198600 has the characteristics such that a battery having a configuration in which a positive electrode sheet and a negative electrode sheet, each including a mixture layer containing an active material on a surface of a current collector composed of a carbon nano-tubes, are laminated or wound through a porous insulating body to constitute an electrode group, and the electrode group is sealed in a battery case in combination with an electrolytic solution, the electrode sheet for a battery which has the above-described structure is used as at least one of the positive electrode sheet and the negative electrode sheet. That is, the mixture layer and the current collector are present individually. Therefore, the carbon nano-tubes only have function as the current collector and is not used for carrying the active material.

In the structure disclosed in Japanese Patent Application Publication No. 2011-198600, a current collector portion can contribute to charging and discharging, and thus it is possible to further improve the capacity of the battery. However, the structure disclosed in Japanese Unexamined Patent Application, First Publication No. 2011-198600 is intended for high capacity, and is not a structure capable of coping with a high output of a battery.

In addition, in the battery of the related art, portions such as a binder and a conductive auxiliary agent other than the active material become a part of constituent members of an electrode, and become resistive components of the electrode. Furthermore, the weight and the volume of the portions other than the active material are included during calculation of an output related to a battery device. Therefore, there is a problem in that an output peculiar to the active material is not sufficiently exhibited.

For example, the structure disclosed in Japanese Unexamined Patent Application, First Publication No. 2013-118126 has the structure in that the composite carrier, in which the composite oxide serving as the active material is carried on the carbon nano-tube, is applied to the positive electrode current collector formed from a metal material. According to this, there is a problem in that the weight and the volume of portions other than the active material and the carbon nano-tubes are included during calculation of an output density related to a battery device. In addition, the carbon nano-tube has a strong cohesive force and tends to form a bundle, and an active material having a fine particle shape also tends to agglomerate. Therefore, there is a problem in that it is difficult to uniformly disperse both the carbon nano-tube and the active material.

In the structure disclosed in Japanese Unexamined Patent Application, First Publication No. 2013-098265, the reaction is allowed to occur in the solution containing the metal compound and the fibrous carbon due to the shear stress and the centrifugal force, whereby the metal compound and the fibrous carbon are allowed to react with each other to generate the composite material. The carbon nano-tube is added to the composite material to obtain a sheet-shaped composite. According to this, there is a problem in that agglomeration of the carbon nano-tube tends to occur by the intermolecular force since carbon nano-tubes are fine fibers, and thus it is difficult to randomly disperse the metal compound in a three-dimensional manner, and an internal resistance tends to increase due to agglomeration. According to this, the structure disclosed in Japanese Unexamined Patent Application, First Publication No. 2013-098265 has characteristics in which the sheet-shaped composite is formed on a surface of the current collector as a countermeasure against insufficient electron conductivity.

In the structure disclosed in United States patent application, Publication No. 2013/0106026, the carbon nano-tube and the active material are separated at once from the solvent without using a dispersing agent, thereby manufacturing the negative electrode for a lithium ion secondary battery. According to this, agglomeration of the carbon nano-tube may occur again, and thus there is a problem in that it is difficult to randomly disperse the active material and the carbon nano-tube in a three-dimensional manner, and the internal resistance tends to increase due to the agglomeration.

According to aspects of the invention, there are provided a current collector also serving as an electrode for a battery, and a battery using the current collector also serving as an electrode, which are capable of accomplishing a high output in combination with a capacity equal to or greater than the capacity of a constituent member of a high-output electrode of the related art, by constructing a fine carbon nano-tube on which an active material is carried and which has high conductivity as a three-dimensional fiber composite and by setting the fine carbon nano-tube as a current collector also serving as an electrode instead of a current collector, a conductive auxiliary agent, and a binder which are constituent members of a high-output electrode of the related art.

To accomplish the above-described object, the invention employs the following configurations.

(1) According to a first aspect of the invention, there is provided a current collector also serving as an electrode for a battery which includes a three-dimensional fiber composite in which a plurality of conductors are disposed in a three-dimensional void of a three-dimensional fiber assembly skeleton, the three-dimensional fiber assembly skeleton being formed by intersecting and assembling a plurality of irregular shaped carbon nano-tubes. An active material that is carried on the carbon nano-tubes or on the conductors is accommodated in the three-dimensional void inside the three-dimensional fiber composite, and the three-dimensional fiber composite is shaped in a sheet shape.

(2) In the above mentioned first aspect, the carbon nano-tubes and the conductors may be contained in a total amount of 1% by mass to 95% by mass.

(3) In the above mentioned second aspect, the carbon nano-tubes and the conductors may be contained in a total amount of 2% by mass to 75% by mass.

(4) In any one of the above mentioned first to third aspects, a length of the carbon nano-tubes which constitute the three-dimensional fiber assembly skeleton may be 0.5 μm to 2 mm, each of the conductors may be a carbon nano-tube, a length of the carbon nano-tube that constitutes the conductor may be 0.01 μm to 2 mm, and sheet resistivity of the carbon nano-tube may be 1×10⁻⁶ Ωcm to 5.6×10⁻¹ Ωcm.

(5) In any one of the above mentioned first to fourth aspects, a pore size distribution of the three-dimensional void, which is formed in the three-dimensional fiber composite, may have a peak at 2 nm to 100 nm.

(6) In any one of the above mentioned first to fifth aspects, a thickness of the current collector also serving as an electrode for a battery may be 10 μm to 1.2 mm.

(7) According to another aspect of the invention, there is provided a battery including the current collector also serving as an electrode for a battery according to any one of the above mentioned first to sixth aspects.

(8) In the above mentioned seventh aspect, a current collection path may be disposed at a part of the current collector also serving as an electrode for a battery along a current extraction direction.

In the current collector also serving as an electrode for a battery according to the first aspect, the plurality of irregular shaped carbon nano-tubes are intersected and assembled to constitute the three-dimensional fiber composite having the sheet shape, and the three-dimensional fiber composite itself plays a role of a conductive base (base material). According to this, a metal current collector, which is necessary for an electrode for a secondary battery of the related art, is not necessary. In addition, active materials, which are carried on the three-dimensional fiber composite of the carbon nano-tubes which has an excellent conductivity, can be accommodated in the three-dimensional void of the three-dimensional fiber composite in a fine particle state and in a state of being close to each other. According to this, a conductive auxiliary agent and a binder, which are necessary for the electrode of the related art, are not necessary.

According to this, it is possible to reduce a weight and a volume which correspond to the metal current collector, a weight and a volume which correspond to the binder, and a weight and a volume which correspond to the conductive auxiliary agent. Accordingly, the active material is increased in proportion to a reduction in the weight and the volume which correspond to the metal current collector, the binder, and the conductive auxiliary agent, and thus it is possible to improve the output and the energy density in the case of constructing the secondary battery. In addition, if the same output and the same energy density as in the related art are acceptable, the current collector, the binder, and the conductive auxiliary agent can be omitted, and thus a reduction in weight and size of an electrode can be realized. Accordingly, this reduction contributes to a reduction in size and weight of a secondary battery.

According to the current collector also serving as an electrode for a battery according to the second aspect, the active material can be carried with the carbon nano-tube and the conductor. According to this, the carbon nano-tube and the conductor, and the active material can be brought into close contact with each other. Accordingly, in comparison to the structure of the related art in which the active material configured in a layer shape is brought into close contact with the current collector, it is possible to remove a layer-shaped interface portion between the active material and the current collector. According to this, it is possible to provide a current collector also serving as an electrode for a battery in which peeling-off does not occur in an interface portion and which is excellent in cycle characteristics even when being used in a secondary battery which is repetitively charged.

Since the active material is carried in an amount of 1% by mass to 95% by mass with respect to the carbon nano-tubes and the conductors, it is possible to realize an electrode structure including the carbon nano-tubes and the active material. According to this, it is possible to provide a current collector also serving as an electrode for a battery which is capable of exhibiting a high output and a high energy density.

According to the current collector also serving as an electrode for a battery according to the third aspect, the mass ratio between the carbon nano-tubes and the active material is set to an appropriate range. According to this, it is possible to provide a current collector also serving as an electrode for a secondary battery which is capable of providing a secondary battery in which a high capacity, a high output, a reduction in size, and a reduction in weight can be realized.

According to the current collector also serving as an electrode for a battery according to the fourth aspect, the length of the carbon nano-tubes which constitute the three-dimensional fiber assembly skeleton is 0.5 μm to 2 mm, and the length of each of the carbon nano-tubes which constitute the conductors is 0.01 μm to 2 mm. According to this, it is possible to construct a three-dimensional composite capable of being used as a self-standing electrode that is easily formed in a sheet shape. In addition, when the sheet resistivity is 1×10⁻⁶ Ωcm to 5.6×10⁻¹ Ωcm, an appropriate sheet resistance is obtained, and active material fine particles can be connected to each other with satisfactory electron conductivity, and thus it is possible to realize an electrode with which a high-output battery can be provided.

According to the current collector also serving as an electrode for a battery according to the fourth aspect, it is possible to construct a three-dimensional fiber composite, which is easily formed in a sheet shape, as a self-standing structure by compressing a plurality of the three-dimensional fiber composites in a layer shape.

According to the current collector also serving as an electrode for a battery according to the fifth aspect, the pore size distribution of the three-dimensional void is set to an appropriate range, and thus it is possible to provide a battery with a high output and a high capacity.

According to the current collector also serving as an electrode for a battery according to the sixth aspect, the thickness is 10 μm to 1.2 mm, and thus it is possible to provide a current collector also serving as an electrode with an appropriate thickness in a sheet shape.

According to the battery according to the seventh aspect, it is possible to provide a battery which accomplishes a high output, a high energy density, a high capacity, a reduction in size, and a reduction in weight.

According to the battery according to the eighth aspect, it is possible to provide a battery with a further higher output.

### BRIEF DESCRIPTION OF THE DRAWINGS

FIG. 1 is a cross-sectional view showing an example of a secondary battery cell structure that employs a current collector also serving as an electrode according to a first embodiment of the invention;

FIG. 2 is an enlarged view showing a three-dimensional fiber composite that constitutes the current collector also serving as an electrode according to the first embodiment, and an active material that is carried inside the three-dimensional fiber composite;

FIG. 3A is a partial configuration view of a cell which shows a laminated cell including the electrode according to the first embodiment;

FIG. 3B is a perspective view showing the laminated cell including the electrode according to the first embodiment in which a part of a laminate type cell is set as a cross-section;

FIG. 4 is a cross-sectional view showing an example of a structure of a secondary battery cell of the related art which employs an electrode of the related art;

FIG. 5 is a cross-sectional view showing an example of a structure of a current collector and an active material which are employed in the secondary battery cell of the related art;

FIG. 6 is a cross-sectional view showing an example of a structure of a secondary battery cell which employs a current collector also serving as an electrode according to a second embodiment of the invention;

FIG. 7 is a partial cross-sectional perspective view showing an example of a structure of a square-type secondary battery including the electrode according to the invention;

FIG. 8 is a partial cross-sectional exploded perspective view showing an example of a structure of a cylindrical secondary battery including the electrode according to the invention;

FIG. 9 is a graph showing comparison between the capacity of a plurality of secondary batteries manufactured in Examples, and the capacity of a secondary battery of the related art;

FIG. 10 is a graph showing comparison between the capacity of a secondary battery manufactured in Examples and the capacity of a secondary battery of the related art;

FIG. 11 is a graph showing comparison between the capacity of secondary batteries manufactured by changing a mixing ratio between a carbon nano-tube and an active material in Examples, and the capacity of a secondary battery of the related art;

FIG. 12 is a view showing a pore size distribution of a three-dimensional fiber composite in accordance with the carbon nano-tube that is used in Examples;

FIG. 13 is a view showing test results of a relationship between the thickness and the capacity of electrodes for a secondary battery which are manufactured in Examples;

FIG. 14 is a graph showing particle size distributions of carbon nano-tubes manufactured in Examples;

FIG. 15 is a graph showing a comparison result between a rate-evaluation result with a laminate half-cell manufactured in Examples, and a rate-evaluation result with an electrode of the related art on the basis of electrode weight;

FIG. 16 is a graph showing comparison of capacity maintenance rates between a structure in which a current collection path is provided to the current collector also serving as an electrode which is manufactured in Examples, and a structure in which the current collection path is not provided;

FIG. 17A is a configuration view showing an example of a cell that is constituted by the current collector also serving as an electrode, which is not provided with the current collection path, as a configuration example of the current collector also serving as an electrode; and

FIG. 17B is a configuration view showing an example of a cell constituted by the current collector also serving as an electrode, which is provided with the current collection path, as a configuration example of the current collector also serving as an electrode.

### DESCRIPTION OF EMBODIMENTS

Hereinafter, description will be given of a current collector also serving as an electrode for a secondary battery according to a first embodiment of the invention, and a structure of a secondary battery cell using the current collector also serving as an electrode with reference to the accompanying drawings in an appropriate manner.

FIG. 1 shows an example of a basic structure of a secondary battery cell that uses the current collector also serving as an electrode for a secondary battery according to the first embodiment. A secondary battery cell structure 1 includes a plurality of electrode pairs in which a sheet-shaped positive electrode (current collector also serving as an electrode) 3 and a sheet-shaped negative electrode (current collector also serving as an electrode) 4 are alternately laminated via a separator 5 at the inside of a casing 2, and the inside of the casing 2 is filled with an electrolytic solution (not shown).

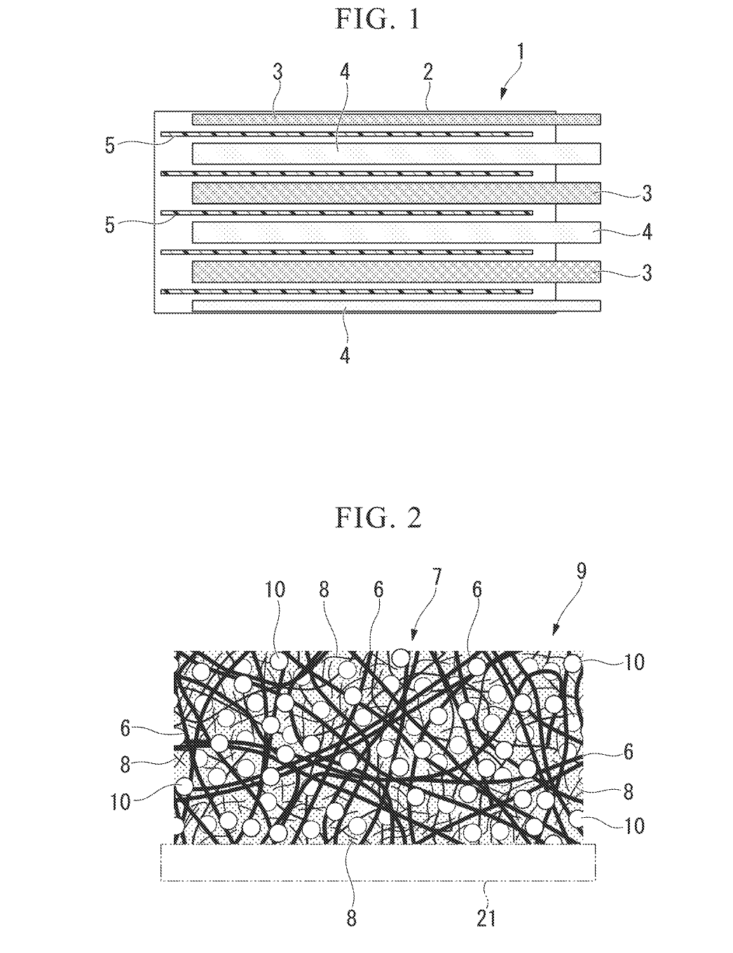

The positive electrode 3 of this embodiment has a structure as shown in FIG. 2 in an enlarged manner.

In the positive electrode 3, a three-dimensional fiber assembly skeleton 7, and a conductor 8 formed in a fibrous shape from a carbon nano-tube or the like which is shorter than a skeleton fiber 6 at the inside of a three-dimensional void of the three-dimensional fiber assembly skeleton 7 are mixed in and are integrally formed, thereby constituting a three-dimensional fiber composite 9. The three-dimensional fiber assembly skeleton 7 is formed by randomly disposing groups of the skeleton fibers 6, which are formed by intersecting and assembling a plurality of irregular shaped carbon nano-tubes, in a three-dimensional shape and by integrally forming the groups. In addition, a plurality of fine particle-shaped active material fine particles 10 are accommodated at the inside of the three-dimensional void of the three-dimensional fiber composite 9 in a state of coming into close contact with the skeleton fiber 6 or the conductor 8 to be carried thereon. In this manner, the positive electrode 3 is constructed.

The skeleton fiber 6 is formed as an assembly obtained by intersecting a plurality of irregular shaped carbon nano-tubes having a length of 0.5 μm to 2 mm. Portions of skeleton fibers 6, which come into contact with each other, come into close contact with each other or come into contact with each other due to an intermolecular force exhibited between the carbon nano-tubes or mechanical entanglement between the carbon nano-tubes.

When the length of each of the skeleton fiber 6 is less than 0.5 μm, it is difficult to construct the three-dimensional fiber assembly skeleton 7 in a self-standing shape such as a sheet shape.

When the length of the skeleton fiber 6 exceeds 2 mm, the carbon nano-tubes come into close contact with each other and agglomerate in a bundle shape in a longitudinal direction, and thus it is difficult to construct the three-dimensional fiber assembly skeleton 7. As a result, it is difficult to construct the electrode 3 having a sheet shape.

The conductor 8 is configured of a conductor such as a carbon nano-tube, Ketjen black, and acetylene black. In a case where the conductor 8 has a fibrous shape, as shown in FIG. 2, the conductor 8 is disposed and distributed to be entangled between the groups of the skeleton fibers 6, and thus contact frequency with the active material increases. Accordingly, it is possible to provide a reaction site with high density, and thus this case is preferable. In addition, when the conductor 8 is constituted by the carbon nano-tube, carbon nano-tubes come into close contact with each other or come into contact with each other with an intermolecular force due to compression between the carbon nano-tube that constitutes the conductor 8 and the carbon nano-tube that constitutes the skeleton fiber 6, and the like. Accordingly, it is preferable to use the conductor 8 that is formed from the carbon nano-tube. In a case where the conductor such as Ketjen black and acetylene black has a particle shape, particles are dispersed in the three-dimensional fiber assembly skeleton 7, thereby constructing the three-dimensional fiber composite 9.

In a case where the conductor 8 is constituted by the carbon nano-tube, it is preferable that the length of the carbon nano-tube that constitutes the conductor 8 is 0.01 μm to 2 mm. When the length of the carbon nano-tube that constitutes the conductor 8 is less than 0.01 μm, the length of the carbon nano-tube becomes too much shorter than the active material fine particles 10, and thus it is difficult to realize conduction with high efficiency.

On the other hand, when the length of the carbon nano-tube exceeds 2 mm, there is a high concern that the carbon nano-tubes come into close contact with each other and agglomerate in a bundle shape in a longitudinal direction. In addition, it is difficult to manufacture a carbon nano-tube having a length exceeding 2 mm with a current technology. Accordingly, when using the carbon nano-tube having a length exceeding 2 mm, it is necessary to manufacture the carbon nano-tube with a special method. Accordingly, the cost of the carbon nano-tube significantly increases, and thus it is not preferable to use the carbon nano-tube for an electrode. It is preferable that the carbon nano-tube, which constitutes the conductor 8, has a length equal to or shorter than that of the carbon nano-tube that constitutes the skeleton fiber 6.

It is preferable that the mass of the skeleton fiber 6 and the conductor 8, which constitute the positive electrode 3, is in a range of 1% by mass to 95% by mass with respect to the total mass of the positive electrode 3. When the total mass of the skeleton fiber 6 and the conductor 8 is less than 1% by mass, the amount of the skeleton fiber 6 and the conductor 8 becomes too small, and thus it is difficult to manufacture a self-standing electrode structure from the carbon nano-tube and the active material fine particles 10.

On the other hand, when the total mass of the skeleton fiber 6 and the conductor 8 exceeds 95% by mass, a ratio of the carbon nano-tube becomes too high in the positive electrode 3. Accordingly, when constructing a secondary battery, capacity becomes insufficient, and thus an output reaches the limit. As a result, when constructing a secondary battery, superiority to a capacitor is not exhibited.

It is preferable that sheet resistivity in the positive electrode 3 is 1×10⁻⁶ Ωcm to 5.6×10⁻¹ Ωcm. Low sheet resistivity is preferable from the viewpoint of a high output, but the sheet resistivity does not become less than (1×10⁻⁶) Ωcm under an operating environment related to a battery.

It is preferable that a pore size distribution of the three-dimensional void formed in the three-dimensional fiber composite constituted by the skeleton fiber 6 and the conductor 8 has a peak at 2 nm to 100 nm. In a case where the peak of the pore size distribution is less than 2 nm, solvation diffusion resistance of Li ions increases, and thus there is a concern that a sufficient output may not be obtained in a case of constructing a secondary battery.

On the other hand, when the peak of the pore size exceeds 100 nm, an electrode density of the positive electrode 3 decreases, and thus a high capacity is not obtained in a case of constructing a secondary battery.

In a case where the positive electrode 3 has a sheet shape, it is preferable that the thickness of the positive electrode 3 is 10 μm to 2 mm. When the thickness of the positive electrode 3 is less than 10 μm, it is difficult to exhibit homogeneity or necessary mechanical strength, and thus requirements for an electrode sheet are not satisfied. On the other hand, when the positive electrode 3 has a thickness greater than 2 mm, there is a concern that sufficient output characteristics may not be obtained in a case of constructing the secondary battery.

It is preferable that an aspect ratio of the carbon nano-tube, which constitutes the skeleton fiber 6, is in a range of 5 to 4000000. When the aspect ratio is less than 5, a contact point between carbon nano-tubes, which form a conductive path as a current collection skeleton, increases, and thus there is a problem in that a contact resistance increases. On the other hand, when the aspect ratio is a value greater than 4000000, agglomeration between the carbon nano-tubes occurs in a longitudinal direction, and thus a frame of a skeleton structure becomes too thick. Therefore, there is a problem in that dispersibility decreases.

It is preferable that the aspect ratio of the carbon nano-tube, which constitutes the conductor 8, is in a range of 2 to 2000000. When the aspect ratio is less than 2, a contact point between carbon nano-tubes, which form a conductive path, increases, and thus there is a problem in that a contact resistance increases. On the other hand, when the aspect ratio is a value greater than 2000000, there is a problem when considering that it is difficult to sufficiently secure a contact point between the carbon nano-tube and the active material.

For example, the casing 2 in the secondary battery cell structure 1 of this embodiment is formed from a metal material such as copper, nickel, stainless steel, nickel-plated steel, aluminum, and an aluminum alloy, or a member obtained by forming a composite of the metal material and a resin sheet and by forming the composite into a laminated sheet.

In a case where the secondary battery is a lithium ion secondary battery, as the active material fine particles 10 for the positive electrode 3, a lithium-containing composite oxide is used. Examples of the lithium-containing composite oxide include LiCoO₂, a modified substance of LiCoO₂, LiNiO₂, a modified substance of LiNiO₂, LiMnO₂, a modified substance of LiMnO₂, and the like. Examples of the modified substances include a modified substance including an element such as aluminum, magnesium, silicon, and phosphorous. In addition, examples of the modified substances include a modified substance including at least two kinds among cobalt, nickel, and manganese.

There is no particular limitation to the active material fine particles 10 as long as the active material fine particles 10 can construct an electrode. However, with regard to a high-output type battery, fine particles having a particle size of 5 nm to 100 nm are preferable. In a structure in which the active material fine particles 10 having a fine particle size are brought into close contact with a carbon nano-tube to be carried thereon in the three-dimensional void of the above-described three-dimensional fiber composite 9, it is possible to construct a high-output secondary battery in which high-speed conduction of Li ions or electrons is realized.

A basic electrode structure of the negative electrode 4 is the same as that of the positive electrode 3 except for an active material. That is, in the negative electrode 4, the three-dimensional fiber assembly skeleton 7, and the conductor 8 formed in a fibrous shape from the carbon nano-tube or the like which is shorter than the skeleton fiber 6 at the inside of a three-dimensional void of the three-dimensional fiber assembly skeleton 7 are mixed in and are integrally formed, thereby constituting the three-dimensional fiber composite 9. The three-dimensional fiber assembly skeleton 7 is formed by randomly disposing groups of the skeleton fibers 6 which are formed from the carbon nano-tube in a three-dimensional shape and by integrally forming the groups. In addition, the following active material is carried on the carbon nano-tube that constitutes the three-dimensional fiber composite 9.

In a case where the secondary battery is a lithium ion secondary battery, as a negative electrode active material, for example, various kinds of natural graphite, various kinds of artificial graphite, hard carbon, a silicon-containing composite material, various alloy materials, and various metal oxides such as Li₄Ti₅O₁₂ can be used.

In this embodiment, both the positive electrode 3 and the negative electrode 4 are constituted by the three-dimensional fiber composite 9. However, only one of the positive electrode 3 and the negative electrode 4 may be constituted by the three-dimensional fiber composite 9.

For example, the separator 5 is configured of a microporous single layer formed from a polyolefin-based resin such as polypropylene and polyethylene, or a laminated body obtained by laminating a plurality of single layers. It is preferable that the thickness of the separator 5 is 10 μm or greater from the viewpoints of securement of insulation properties between the positive electrode and the negative electrode and maintenance of an electrolytic solution. On the other hand, it is more preferable that the thickness of the separator 5 is 30 μm or less from the viewpoint of maintenance of designed capacity of a battery.

For example, the electrolytic solution is formed from a nonaqueous solvent and a lithium salt that is dissolved in the nonaqueous solvent. For example, LiPF₆ or LiBF₄ is used as the lithium salt. For example, ethylene carbonate (hereinafter, referred to as “EC”), propylene carbonate, dimethyl carbonate, diethyl carbonate or methyl ethyl carbonate (hereinafter, referred to as “MEC”) is used as the nonaqueous solvent. These nonaqueous solvents are used alone or in combination of two or more kinds thereof. In addition, vinylene carbonate, cyclohexyl benzene, fluoroethylene carbonate, or a modified substance thereof may be added to the nonaqueous electrolytic solution. In addition, an ionic liquid such as 1-ethyl-3-methylimidazolium tetrafluoroborate (EMI-BF) may be used instead of the electrolytic solution as described above.

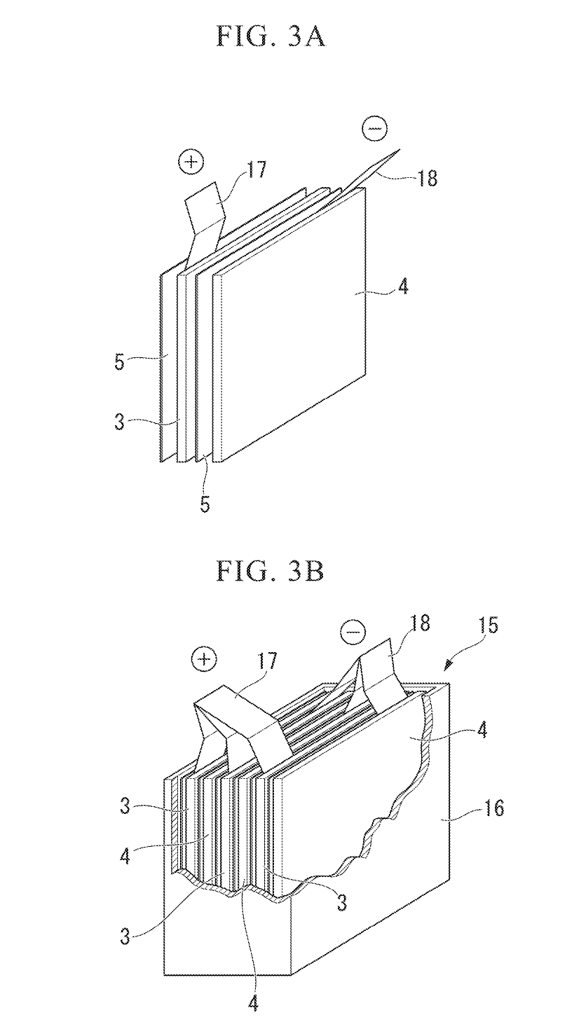

FIGS. 3A and 3B show an example of a structure of a laminate type secondary battery cell including the positive electrode 3 and the negative electrode 4 which have a structure shown in FIGS. 1 and 2.

A secondary battery cell 15 has the structure in that the plurality of electrode pairs in which the positive electrode 3 and the negative electrode 4 are laminated via the above described separator 5 are accommodated in a box-shaped casing 16, the inside of the casing 16 is filled with an electrolytic solution, a plurality of the positive electrodes 3 are connected to each other by a plurality of lead sheets 17, and a plurality of the negative electrodes 4 are connected to a plurality of lead sheets 18.

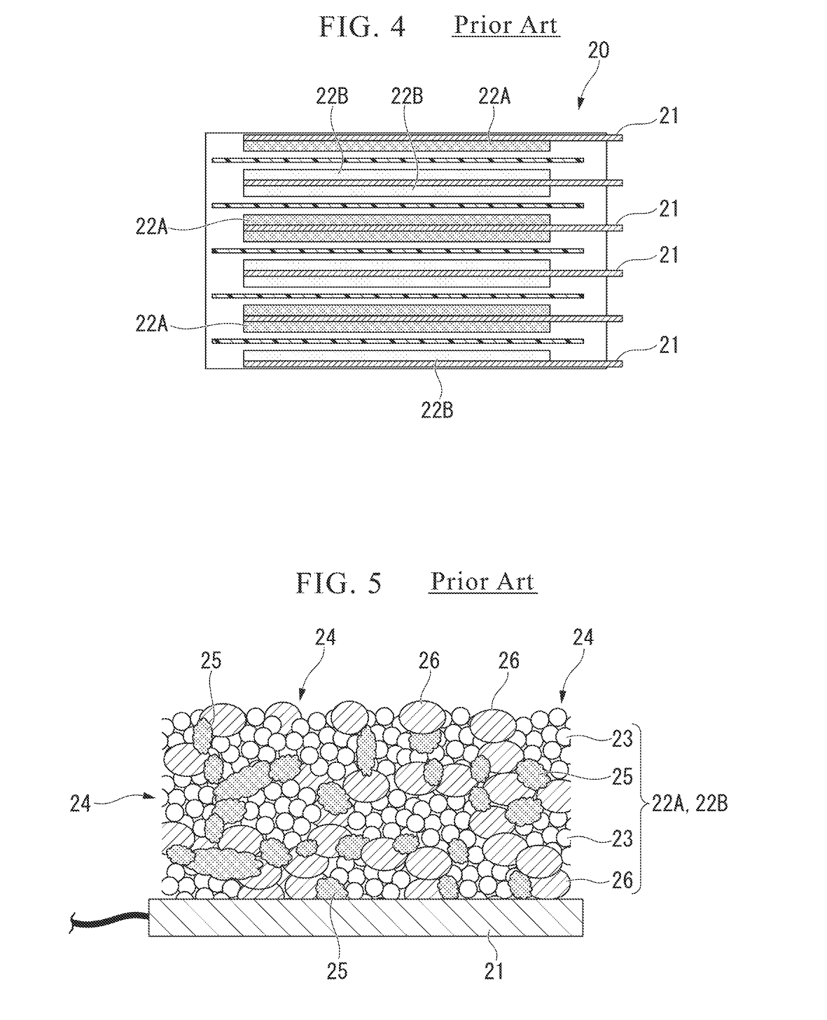

FIGS. 4 and 5 show a secondary battery cell structure 20 including a current collector of the related art for comparison between the secondary battery cell structure 1 or the secondary battery cell 15 of this embodiment, and a structure of the related art.

In the secondary battery cell structure 20, a mixture layer 22A for a positive electrode or a mixture layer 22B for a negative electrode is applied to one surface or both surfaces of a sheet-shaped current collector 21 formed from a metal.

As shown in FIG. 5, the mixture layer 22A (22B) has a structure in which a mixture of a granulated body 24 of active material fine particles 23, a particle-shaped conductive auxiliary agent 25, and a particle-shaped binder (binding agent) 26 is compacted.

The mixture layer 22A (22B) is formed on one surface or both surfaces of the current collector 21 through application, and thus it is necessary for the mixture layer 22A (22B) to be applicable to the current collector 21. Application cannot be performed in a state of the active material fine particles 23. Accordingly, the active material fine particles 23 are granulated to certain large particles, and are mixed with the conductive auxiliary agent 25 and the binding agent 26, thereby constructing the mixture layer 22 that is applicable to the current collector 21.

In the structure shown in FIG. 5, the binder 26 that does not conduct electrons is present at the periphery of the granulated body 24 constituted by the active material fine particles 23, and thus an internal resistance of the mixture layer 22 increases due to the presence of the binder 26. That is, the internal resistance is large in a case where electrons are allowed to reach the current collector 21 from the granulated body 24 of the active material fine particles 23. In addition, a surface layer such as a solid electrolyte interface (SEI) and an oxide film is present on a surface of the current collector 21, and thus a resistance increases in a case where electrons attempt to flow to the current collector 21. In addition, a resistance is also present in a case where electrons are conducted to the current collector 21 along particles of the conductive auxiliary agent 25. In the structure of the related art which is shown in FIG. 5, a basis performance of a battery which is to be originally obtained by the active material cannot be sufficiently exhibited.

In comparison to the structure shown in FIG. 5, the positive electrode 3 and the negative electrode 4, which are configured as described above, have a structure in which the active material fine particles 10 are carried on the three-dimensional fiber composite 9 in which the three-dimensional fiber assembly skeleton 7 formed from the carbon nano-tube and the conductor 8 are mixed in and are integrally formed. According to this, it is possible to omit the binder and the conductive auxiliary agent which were necessary for the electrode for a secondary battery of the related art. That is, the active material fine particles 10 come into close contact with the carbon nano-tube excellent in conductivity, and thus electron conduction from individual active material fine particles 10 is sufficiently performed via the carbon nano-tube. Accordingly, a structure excellent as an electrode for a secondary battery is obtained.

In addition, the active material fine particles 10 having a small particle size come into close contact with the three-dimensional fiber composite 9 formed from the carbon nano-tube having satisfactory conductivity. According to this, a reaction point of the active material fine particles 10 increases, and thus diffusion of electrons or Li ions occurs smoothly. Accordingly, a performance as an electrode, which is to be originally obtained by the active material, is exhibited.

The three-dimensional fiber composite 9 can self-stand and maintain its own shape, and the three-dimensional fiber composite 9 serves as a conductive substrate. Accordingly, in a structure of this embodiment which is shown in FIGS. 1 and 2, it is possible to completely remove or to significantly reduce the metal sheet such as the current collector. For comparison, the current collector 21, which is omitted, is shown in FIG. 2 with imaginary lines (two-dot chain lines).

Accordingly, the current collector 21, which is necessary for the structure of the related art, is omitted in the structure shown in FIG. 2, or significantly reduced by constructing the current collector 21 only with a conductive path, and the binder and the conductive auxiliary agent can be also omitted. According to this, the amount of the active material fine particles 10 can be increased in proportion to the omission, and thus it is possible to exhibit an effect relating to high output and high capacity for the secondary battery cell structure 1. In addition, when the capacity or the output is set to be the same as that of the secondary battery of the related art, it is possible to provide the secondary battery cell structure 1 in which reduction in size and weight is realized in proportion to reduction in weight and volume of the binder, the conductive auxiliary agent, and the current collector. In addition, a main component that constitutes the three-dimensional fiber composite 9 is the carbon nano-tube, and the carbon nano-tube is lighter in weight in comparison to a metal such as aluminum that constitutes the current collector 21. Accordingly, the carbon nano-tube contributes to a reduction in weight.

In addition, the carbon nano-tube and the active material fine particles 10, which constitute the three-dimensional fiber composite 9, come into close contact with each other. Accordingly, in the secondary battery cell structure 1 of this embodiment, a layer interface with a layer, which includes the current collector 21 and the active material, similar to the structure of the related art is not present. According to this, it is possible to provide the secondary battery cell structure 1 in which peeling-off from the interface portion due to repetitive use as a secondary battery is less likely to occur, and which is excellent in cycle characteristics. For example, in the structure of the related art which is shown in FIG. 5, a layer interface between the mixture layer 22 and the current collector 21 is present. According to this, the mixture layer 22 that is applied to the current collector 21 is peeled off from the current collector 21 due to repetitive use, and thus there is a case where the performance of the secondary battery significantly deteriorates.

In the secondary battery cell structure 1 or the secondary battery cell 15 which is shown in FIG. 1, a current collector is substantially unnecessary. In the secondary battery of the related art, a current concentration phenomenon occurs due to internal short-circuit, and in a case where the internal short-circuit locally occurs, there is a concern that a self-heating reaction (a thermite reaction) may consecutively occur due to oxidation from aluminum. However, in the structure of this embodiment, the secondary battery cell structure 1 or the secondary battery cell 15 does substantially not include the metal current collector, and thus the self-heating reaction does not occur. Accordingly, the effect of an improvement in safety is also provided.

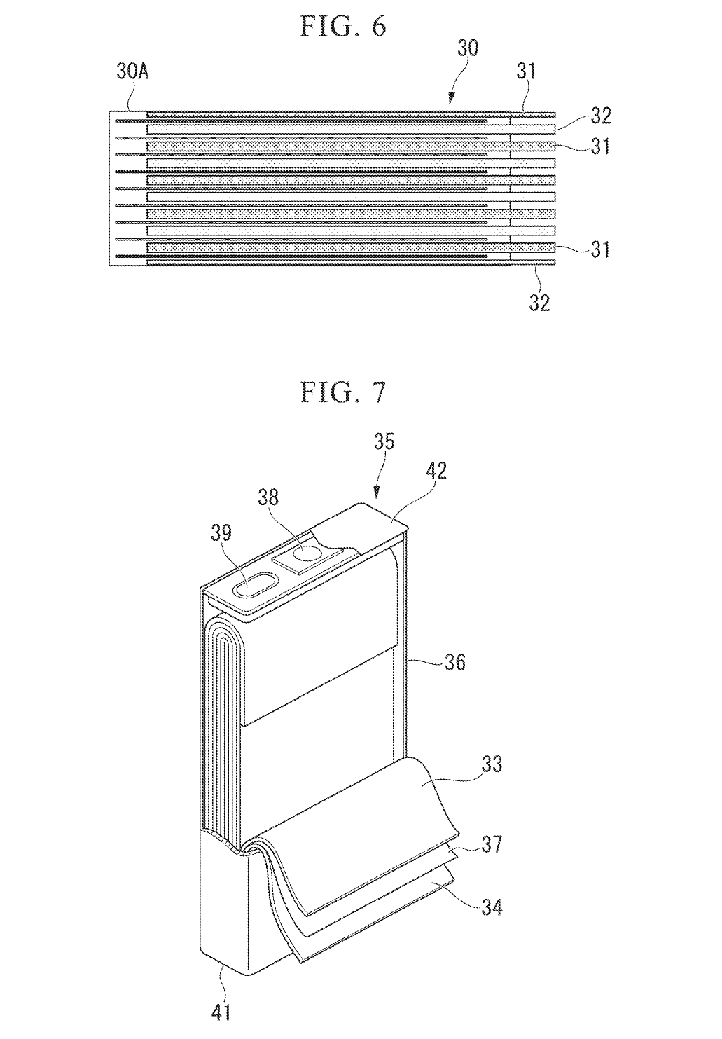

FIG. 6 shows a secondary battery cell structure 30 according to a second embodiment which is obtained in a case of performing film thinning for an improvement in an output. The secondary battery cell structure 30 has a configuration in which a plurality of positive electrodes 31 and negative electrodes 32, which are subjected to the film thinning, are alternately laminated via a separator 33 at a box-shaped casing 30A. The structure according to this embodiment includes the positive electrodes 31 and the negative electrodes 32, which have the same structures as those of the positive electrode 3 and the negative electrode 4 which are shown in FIGS. 1 and 2.

Even in a case where the electrode including the mixture layer 22 shown in FIG. 5 is configured to have a thin film structure shown in FIG. 6, the weight and the volume of the current collector (current collector foil) do not vary when considering each of the positive electrodes and the negative electrodes as a single electrode. In a case where the structure shown in FIG. 5 is just simply changed to the thin film structure, relative weight and capacity of a current collector portion that is occupied in one electrode increase, and as a result, the total capacity density of the secondary battery cell decreases, and thus the output density reaches the limit.

In contrast, in the structure shown in FIG. 6 according to the second embodiment of the invention, the positive electrode 31 and the negative electrode 32, which have the same structures as those of the positive electrode 3 and the negative electrode 4 shown in FIGS. 1 and 2, are provided, an electrode structure in which an internal resistance component is low is provided, and a current collector foil portion is not present. According to this, it is possible to significantly improve an output while maintaining a cell capacity due to the film thinning of the electrode.

In addition, in the secondary battery cell structure 30 of the second embodiment, even though the total weight of the active material in a cell is the same, a multi-layer structure can be realized, and thus a high output can be obtained.

FIG. 7 shows a square-type secondary battery cell 35 using a positive electrode 33 and a negative electrode 34 which have the same structures as those of the positive electrode 3 and the negative electrode 4. The positive electrode 33 and the negative electrode 34, which are separated by a separator 37, are accommodated inside a thin box-type metal case 36 together with an electrolytic solution (not shown). A positive electrode terminal 38 and a safety valve 39 are provided on an upper-end opening side of the case 36, a negative electrode terminal 41 is formed on a bottom side of the case 36, and the upper-end opening side of the case 36 is partially covered with a resin cover 42. The positive electrode 33 is connected to the positive electrode terminal 38 and the negative electrode 34 is connected to the negative electrode terminal 41 at the inside of the case 36.

Even in the square-type secondary battery cell 35 having the structure shown in FIG. 7, the positive electrode 33 and the negative electrode 34, which have the same structures as those of the positive electrode 3 and the negative electrode 4, are provided. According to this, in addition to a reduction in an internal resistance component of an electrode, the current collector necessary for the structure in the related art can be omitted, and the binder and the conductive auxiliary agent can also be omitted. The amount of the active material fine particles 10 which are provided to each electrode can be increased in proportion to the omissions, and thus it is possible to exhibit an effect relating to high output and high capacity as the secondary battery cell 35. In addition, when the capacity or the output is set to be the same as that of the secondary battery of the related art, it is possible to provide the secondary battery cell 35 in which reduction in size and weight is realized in proportion to reduction in volume of the binder, the conductive auxiliary agent, and the current collector.

With regard to the other operational effects, it is possible to obtain the same operational effects as the operational effects which can be exhibited by the secondary battery cell including the positive electrode 3 and the negative electrode 4.

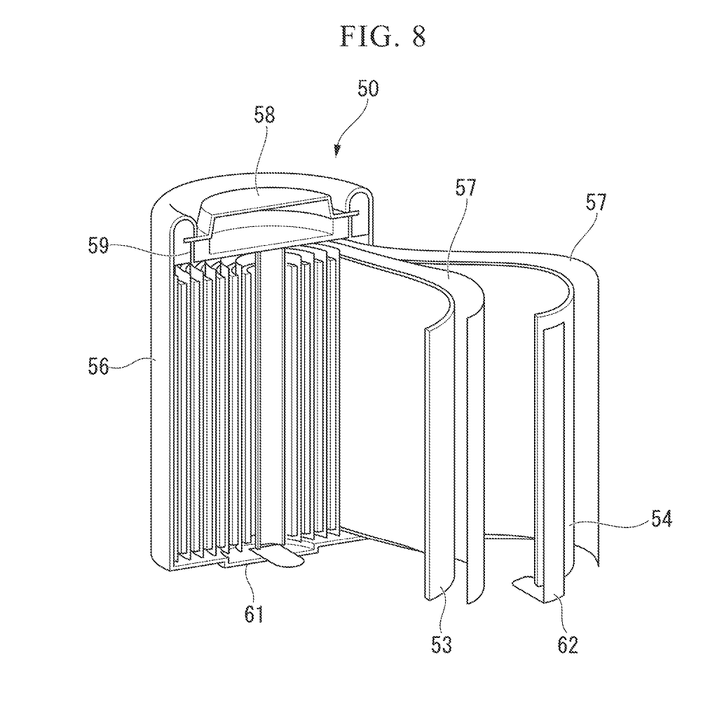

FIG. 8 shows a cylindrical secondary battery cell 50 using a positive electrode 53 and a negative electrode 54 which have the same structures as those of the positive electrode 3 and the negative electrode 4. The positive electrode 53 and the negative electrode 54, which are separated by a separator 57, are wound in a roll shape, and are accommodated inside a cylindrical metal case 56 together with an electrolytic solution (not shown). A cap-shaped positive electrode terminal 58 and a gasket 59 are provided on an upper-end opening side of the case 56, and a negative electrode terminal 61 is formed on a bottom side of the case 56. At the inside of the case 56, the positive electrode 53 is connected to the positive electrode terminal 58 via a positive electrode tab (not shown), and the negative electrode 54 is connected to the negative electrode terminal 61 via a negative electrode tab 62. In addition, although not shown in FIG. 8, an insulating sheet is provided on the bottom of the case 56, and thus the positive electrode 53 and the negative electrode terminal 61 are insulated. In addition, although not shown in FIG. 8, an insulating sheet is provided at an upper portion of the case 56, and thus the negative electrode 54 and the positive electrode 53 are insulated.

Even in the cylindrical secondary battery cell 50 shown in FIG. 8, the positive electrode 53 and the negative electrode 54 which have the same structures as those of the positive electrode 3 and the negative electrode 4 are provided. According to this, the current collector necessary for the structure in the related art can be omitted, and the binder and the conductive auxiliary agent can also be omitted. Accordingly, the amount of the active material fine particles 10 which are provided to each electrode can be increased in proportion to the omissions, and thus it is possible to exhibit an effect relating to high output and high capacity as the secondary battery cell 50. In addition, when the capacity or the output is set to be the same as that of the secondary battery in the related art, it is possible to provide the secondary battery cell 50 in which reduction in size and weight is realized in proportion to reduction in volume of the binder, the conductive auxiliary agent, and the current collector.

With regard to the other operational effects, it is possible to obtain the same operational effects as the operational effects which can be exhibited by the secondary battery cell having a structure including the positive electrode 3 and the negative electrode 4.

In the above-described embodiments, description has been given of an example in which the invention is applied to a secondary battery cell having various structures in which the electrode having a structure according to the invention is applied to a positive electrode and a negative electrode. However, the electrode according to the invention is applicable to an electrode for a secondary battery having various structures including a positive electrode and a negative electrode without limitation to the secondary battery cell or the secondary battery cell structure of the embodiments described above. Accordingly, the electrode of the invention is applicable to all secondary batteries including electrodes without limitation to the secondary batteries having structures shown in FIGS. 1 to 8.

Hereinafter, description will be given of an example of a method of manufacturing the positive electrode 3 that is constituted by the three-dimensional fiber composite.

When manufacturing the positive electrode 3 having the above-described structure, the carbon nano-tube that is used to construct the skeleton fiber in the above-described length range, the carbon nano-tube and the like that is used to construct the conductor in the above-described length range, and the above-described active material fine particles, are mixed in a solvent in a target ratio. It is preferable to perform a process of compulsory dispersing the carbon nano-tubes and the active material in the solvent so as to obtain a uniformly dispersed mixed solution.

Next, when the mixed solution is allowed to pass through a filtration filter and is suction-filtered, it is possible to obtain a sheet-shaped three-dimensional fiber composite 9 in which groups of the skeleton fibers constituted by a carbon nano-tube are randomly disposed in a three-dimensionally shape on a surface of the filtration filter and are integrally formed thereon. When the filtered material is separated from the filter, it is possible to obtain the positive electrode 3 in which a plurality of the active material fine particles 10 are carried inside the three-dimensional fiber composite 9 and which is constituted by a current collector also serving as an electrode for a secondary battery.

In the case of the mixing, as an example, when performing dispersion of the carbon nano-tube, a wet-type pulverizing apparatus NanoVater (registered trade mark: manufactured by Yoshida Kikai Co., Ltd.) or a starbust manufactured by Sugino Machine Limited is used, and uniform three-dimensional random dispersion of the carbon nano-tube can be allowed to occur due to an effect of a shear force and turbulence which are generated when the carbon nano-tube is allowed to pass through a nozzle under a high pressure.

In a case where the thickness of the obtained sheet-shaped current collector also serving as an electrode for a secondary battery is insufficient with only one layer, a plurality of sheets can be laminated and compressed to obtain the current collector also serving as an electrode for a secondary battery which has a necessary thickness.

When using the wet-type pulverizing apparatus NanoVater (registered trade mark: manufactured by Yoshida Kikai Co., Ltd.) or a starbust, it is possible to realize a three-dimensional random dispersion of the constituent members in a solvent, and thus it is possible to manufacture the sheet-shaped current collector also serving as an electrode which is constituted by the three-dimensional fiber composite. For example, in a case where the active material or the carbon nano-tube is present in the dispersed solution in an agglomerated state, agglomeration of the active material or the carbon nano-tube may be left in a sheet that is obtained. As a result, an internal resistance component is exhibited, and thus there is concern that the obtained sheet may not function as the sheet-shaped current collector also serving as an electrode. In consideration of this problem, for example, in a case where a homogeneous dispersed solution is obtained, a dispersion method such as an ultrasonic homogenizer and an ultrasonic bus is applicable.

### EXAMPLES

90 mL of an aqueous solvent, which contains the carbon nano-tube in a ratio of 0.3 mg/mL, was subjected to a treatment using the ultrasonic homogenizer at 50 W for 60 minutes, thereby preparing a primary dispersed solution.

Then, a dispersed solution was obtained through a treatment of performing cross-flow five times by using NanoVater (registered trade mark: manufactured by Yoshida Kikai Co., Ltd.) under conditions of a nozzle diameter of 100 μm and 200 MPa. The dispersed solution was put into a suction-filtering apparatus, and a mixture of the carbon nano-tube and the active material was deposited on a filter having a pore size of 0.1 μm. According to this, the current collector also serving as an electrode for a secondary battery, in which the active material fine particles are carried on the three-dimensional fiber assembly skeleton in a state of coming into close contact with the carbon nano-tube, is obtained. The three-dimensional fiber assembly skeleton is formed by randomly disposing groups of skeleton fibers constituted by the carbon nano-tube in a three-dimensional shape and by integrally forming the groups in a sheet shape.

In addition, an amount of blending active material (LiFePO₄) in a predetermined mass with respect to the mass of the carbon nano-tube in a solvent was changed as described below, thereby manufacturing the current collector also serving as an electrode for a secondary battery.

After suction filtration, a deposited material on the surface of the filtration filter was peeled off, thereby obtaining a sheet-shaped current collector also serving as an electrode for a secondary battery (positive electrode).

As the carbon nano-tube, which was used in the case of manufacturing the current collector also serving as an electrode for a secondary battery, the following three kinds of carbon nano-tubes can be exemplified, and a plurality of current collectors also serving as an electrode for a secondary battery were obtained by properly using the following three kinds of carbon nano-tubes.

HONDA-MWNT (multi-wall nano-tube, diameter: 10 nm to 50 nm, length: 100 μm to 500 μm, manufactured by Honda Motor Co., Ltd.)

e-DIPS (MEIJO eDIPS, part number: EC-P, diameter: 1.7 nm to 2.1 nm, manufactured by Meijo Nano Carbon Co., Ltd.)

CoMoCAT (single-layer carbon nano-tube, part number: SG65i, average diameter: 0.78 nm, manufactured by SIGMA-ALDRICH Corporation)

A charging and discharging test was performed by using a bipolar electrochemical test cell, and a rate evaluation of a positive electrode (current collector also serving as an electrode for a secondary battery) was performed in a half cell in which metal Li foil (t=0.5 μm) was set as a negative electrode.

As the positive electrode active material, iron olivine (average particle size: 60 nm to 100 nm, manufactured by Mitsui Engineering & Shipbuilding Co., Ltd.) was used, and a rate test was performed in a range of 4 V to 2.5 V.

Hipore (t=0.25 μm, manufactured by Asahi Kasei E-materials Corporation) was used as the separator, and (LiPF₆, 1M, EC/DEC 3:7) was used as a nonaqueous electrolytic solution. The negative electrode Li foil, the separator, and the positive electrode (current collector also serving as an electrode for a secondary battery: carbon nano-tube+LiFePO₄) were laminated in this order from a depth side of the bipolar electrochemical cell, thereby constructing a half cell by the bipolar electrochemical test cell.

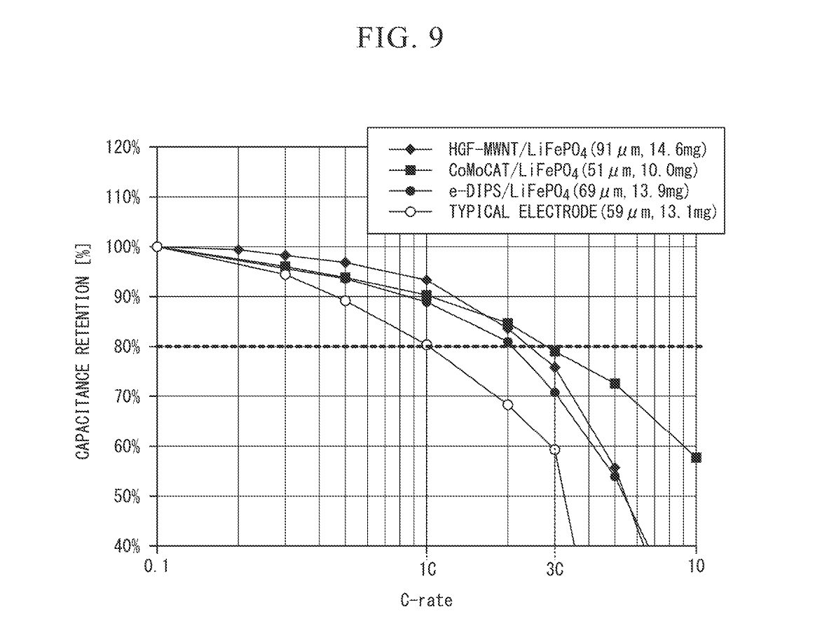

The thickness of each of the current collectors also serving as an electrode for a secondary battery which were obtained from the above-described three kinds of carbon nano-tubes (CNT), and the amount of the active material that was carried are shown in FIG. 9. The mixing ratio of the active material and the CNT was set to 85:15.

In addition, for comparison, a positive electrode (electrode of the related art) as a typical electrode was constructed. The typical electrode was obtained as follows. The same active material as in Examples was used, Ketjen black (ECP600JD: product name, manufactured by Lion Corporation) was used as the conductive auxiliary agent, and PVDF (manufactured by Kureha Battery Materials Japan Co., Ltd.) was used as the binder. These materials were mixed in a ratio of 85:10:5 such that the ratio of the active material became the same as in Examples, thereby obtaining a mixture layer. The mixture layer was applied onto an aluminum sheet current collector, thereby constructing the typical electrode.

Metal Li foil (t=0.5 μm) was used as a negative electrode, Hipore (t=25 μm, manufactured by Asahi Kasei E-materials Corporation) was used as a separator, and (LiPF₆, 1 M, EC/DEC 3:7) was used as a nonaqueous electrolytic solution, thereby constructing a secondary battery of the related art.

FIG. 9 shows results obtained by measuring discharging rate characteristics (at 25° C.) of the various secondary batteries which were obtained. In FIG. 9, a C-rate represents an amount of electricity which can be fully charged in one hour. In a secondary battery sample of the related art, a capacity of 80% is obtained at a C-rate of 1, but in samples using the above-described three kinds of carbon nano-tubes, a capacity of 70% to 80% is obtained even in a C-rate of 3. 1 C represents a current value when a secondary battery cell having a nominal capacity value is discharged with a constant current, and discharging is terminated in one hour. 3 C represents a current value when discharging is terminated in three hours.

The secondary batteries using the electrodes according to the invention exhibited characteristics superior to those of a secondary battery using the electrode of the related art in any rate. Particularly, values at rates such as 3 C and 5 C are more excellent in comparison to the secondary battery having the structure of the related art, and the results represent that charging and discharging can be performed in a satisfactory manner even when a current is allowed to severely flow. From the results, it can be seen that an excellent output related to a secondary battery is provided.

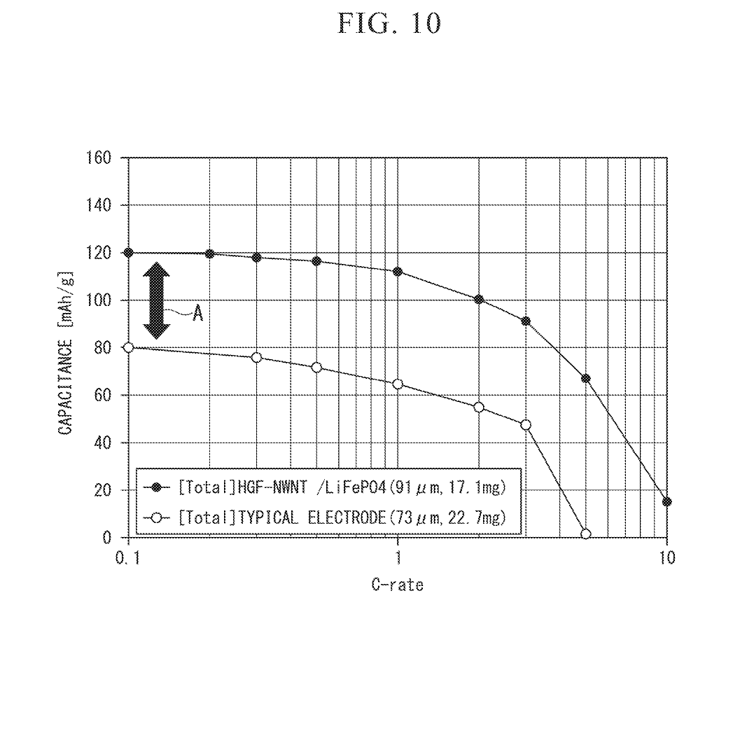

When constructing the secondary batteries in the same size as in Example 1, FIG. 10 is a graph showing comparison of discharging rate characteristics between a case of constructing the secondary battery by using the electrode of the invention and a case of constructing the secondary battery by using the typical electrode.

The electrode according to the invention does not include a current collector, and thus it is possible to reduce the weight and the volume of the electrode in proportion to the weight and the volume of the current collector.

Similar to results shown in FIG. 10, it was proven that in the electrode according to the invention, the capacity could be increased by approximately 30% per weight of an electrode in comparison to the typical electrode. That is, as indicated by an arrow A in FIG. 10, when using the electrode of the invention as an electrode not including a current collector, there was an effect of realizing capacity up by approximately 30% per weight of the electrode in comparison with the typical electrode.

Next, when manufacturing an electrode that was constructed by using the carbon nano-tube (HONDA-MWNT), in a case of manufacturing the electrode by changing the ratio (CNT ratio: % by mass) of the carbon nano-tube included in the electrode, a correlation between a total mass (mg) of the electrode, a film thickness (μm), a resistance (Ω), a sheet resistance (Ω/□), resistivity (Ω·cm), and conductivity (S/cm) was examined. The results are described in Table 1.

HONDA-MWNT is obtained by peeling-off of the carbon nano-tube which has a length of 100 μm to 500 μm and which is vertically oriented on a Si wafer of 4 inches to 8 inches. Synthesis was performed in a vertical type catalytic chemical vapor deposition (CCVD) apparatus.

The Si wafer of 4 inches to 8 inches which is used for synthesis may or may not have a surface oxidation film.

In a case of selecting a two-layer structure as a catalyst layer for CNT composition, it is assumed that as a catalyst layer 1, aluminum or aluminum oxide of 2.5 nm to 10 nm is attached to a surface of the Si wafer, and as a catalyst layer 2, iron or iron oxide of 0.5 nm to 2.5 nm is attached to an outermost surface of the Si wafer. At this time, composition atoms of a Si substrate and each catalyst layer may migrate to an adjacent catalyst layer due to diffusion, and may form an alloy. According to this, with regard to the composition of the catalyst layer, a film, which is formed in a range of 3 nm to 12.5 nm by using alloys of Al—Si, Al—Fe, and Al—Si—Fe, and oxides thereof, may be used.

The synthesis of HONDA-MWNT was performed under conditions of a synthesis temperature of 650° C. to 800° C., a gas flow rate of He/C₂H₂/H₂=2.50-4.60/0.05-0.30/0.10-0.90 (SLM), and a synthesis time of 5 minutes to 60 minutes.

TABLE 1

| | | Film | | Sheet | | |
|---|---|---|---|---|---|---|
| CNT | | thickness | Resistance | resistance | Resistivity | Conductivity |
| ratio (%) | Mass (mg) | (μm) | (Ω) | (Ω/□) | (Ω · cm) | (S/cm) |
| 1 | 1.720E+01 | 1.110E+02 | 1.736E+01 | 4.298E+01 | 4.943E−01 | 2.023E+00 |
| 5 | 1.410E+01 | 8.300E+01 | 3.395E+00 | 1.416E+01 | 6.931E−02 | 1.446E+01 |
| 15 | 2.625E+01 | 1.520E+02 | 1.067E+00 | 4.450E+00 | 2.983E−02 | 3.369E+01 |
| 25 | 1.472E+01 | 1.349E+02 | 4.358E−01 | 1.818E+00 | 1.955E−02 | 5.145E+01 |
| 50 | 1.868E+01 | 2.226E+02 | 2.076E−01 | 8.658E−01 | 1.653E−02 | 6.145E+01 |
| 75 | 1.245E+01 | 1.687E+02 | 1.891E−01 | 7.886E−01 | 1.100E−02 | 9.347E+01 |
| 95 | 1.610E+01 | 2.430E+02 | 1.040E−01 | 4.338E−01 | 1.054E−02 | 9.487E+01 |
| 100 | 2.090E+00 | 4.067E+01 | 7.090E−01 | 2.957E+00 | 1.177E−02 | 8.504E+01 |

From results shown in Table 1, resistivity of 0.5 Ω·cm or less is obtained in a ratio of the carbon nano-tube up to 1% by mass, and this result is superior to 0.56 Ω·cm to 10.0 Ω·cm that is the resistivity of a mixture layer of the electrode in the related art. Accordingly, it can be assumed that this ratio is applicable.

However, even when the sheet of the electrode is 1 wt. % or less, the sheet can function as an electrode, but the mechanical strength of the electrode sheet decreases. Therefore, it is difficult to secure self-standing properties of the sheet, and thus it is difficult to apply the electrode sheet without a support.

In contrast, when the ratio of the carbon nano-tube is 2% by mass or greater, it can be confirmed that a self-standing sheet without deficiency is obtained, and it is preferable that the ratio of the carbon nano-tube is 2% by mass or greater from the viewpoint of securing the mechanical strength that is demanded for a self-standing sheet.

In addition, when the sheet resistance of the electrode is equal to or greater than the lower limit, which is 5.6×10⁻¹ Ωcm, of the resistivity of the mixture layer in the related art, an output becomes equal to or less than that of the electrode in the related art. According to this, the resistivity of the sheet, in which the carbon nano-tube is set as a three-dimensional skeleton, is preferably 5.6×10⁻² Ωcm or less.

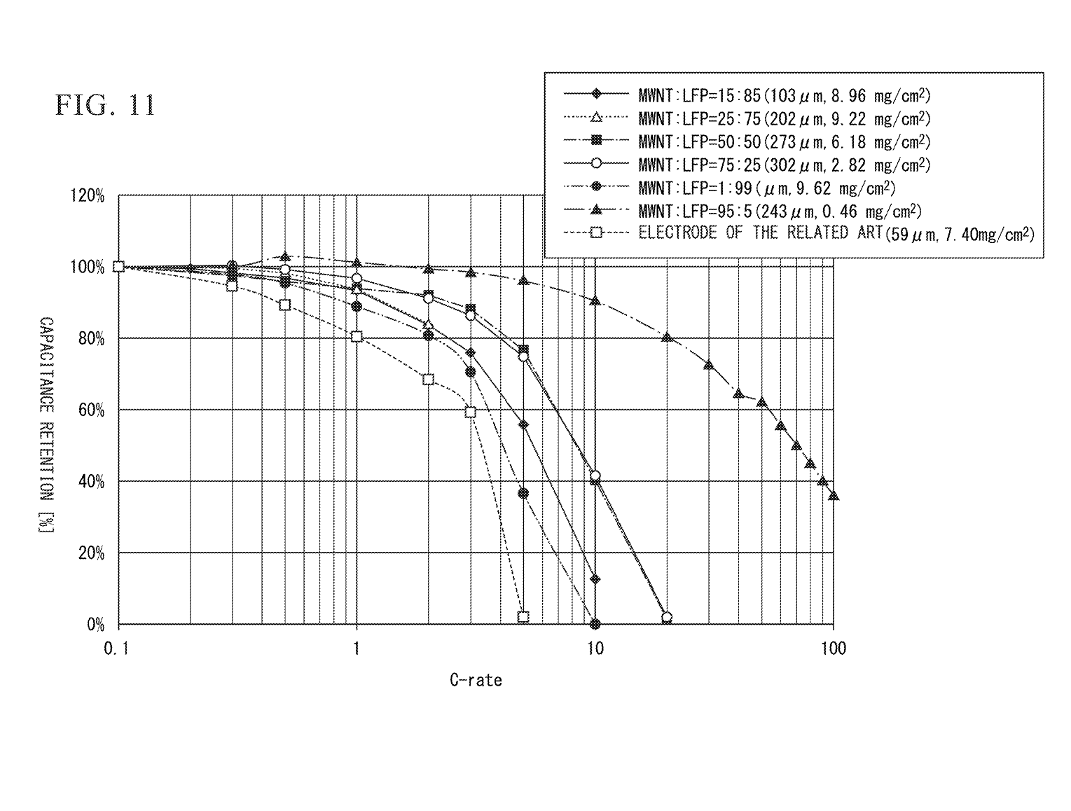

FIG. 11 is graph showing comparison of discharging rate characteristics between secondary batteries manufactured by using electrodes in which the carbon nano-tube (CNT) ratio is changed.

From results shown in FIG. 11, according to the ratio of the amount of the carbon nano-tube and the amount of active material, it can be seen that C-rate characteristics are more excellent in comparison to the electrode of the related art in a range of 1% by mass to 95% by mass.

When the ratio of CNT is 95% by mass or greater, the ratio of capacity of electrical double layers increases with respect to the capacity of the active material, and thus in a case of constructing a secondary battery, capacity becomes insufficient. Therefore, the output reaches the limit. According to this, in a case of constructing a secondary battery, superiority to a capacitor is not exhibited.

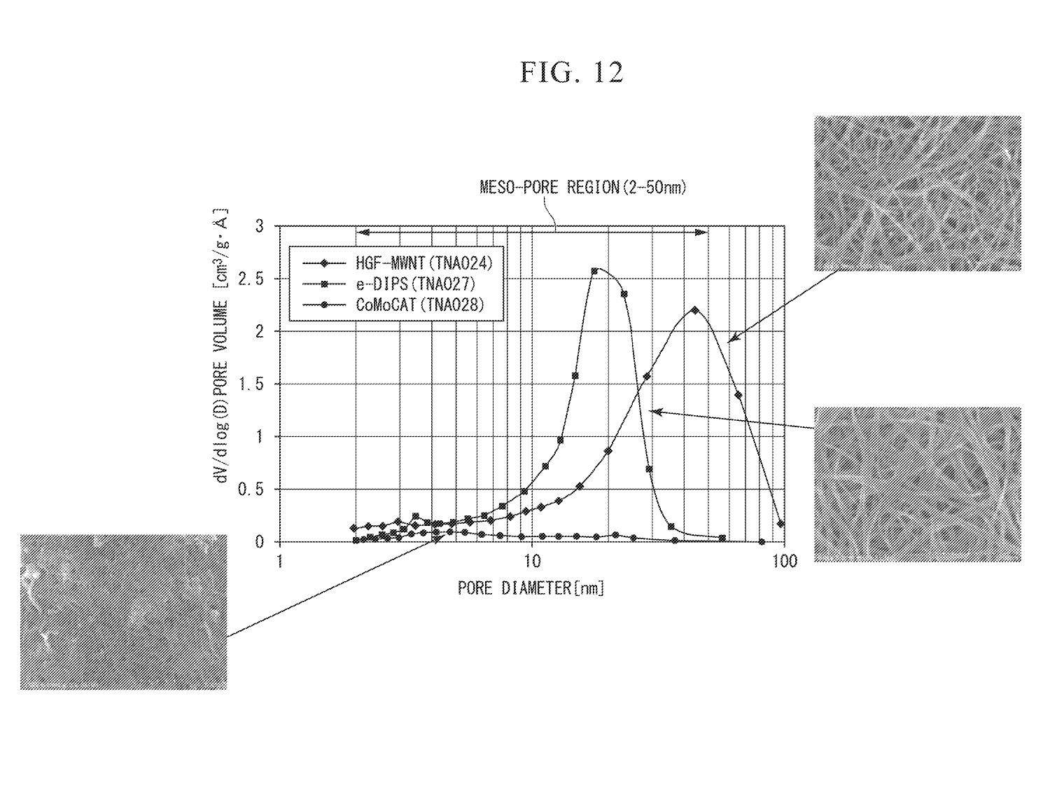

FIG. 12 shows a pore size distribution in accordance with a BET (surface area measurement according to a BET method) of the three kinds of carbon nano-tubes which are used to manufacture secondary battery samples.

It could be confirmed that the maximum value of the pore size of the carbon nano-tube that was used was in a range of 2 nm to 100 nm. It is considered that it is necessary to have a peak of the pore size in this range for a high output of a secondary battery from the viewpoints of high-speed diffusion and migration in electrolyte solvation.

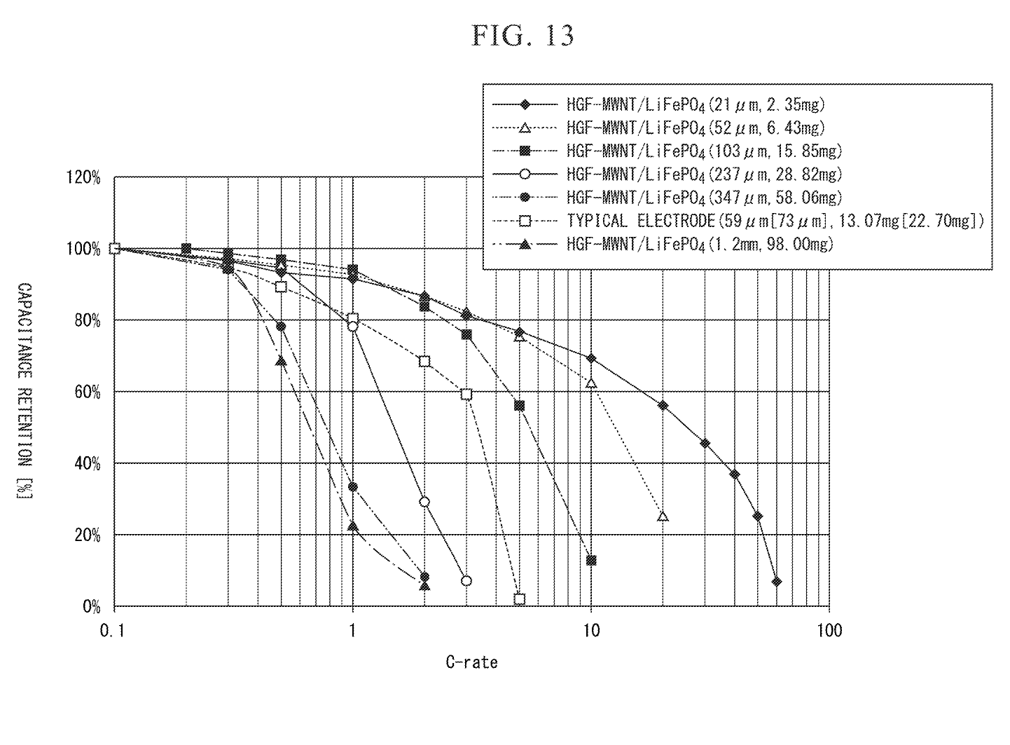

FIG. 13 is a graph showing comparison of discharging rate characteristics between secondary batteries which are constructed by using electrodes obtained by changing a thickness.

In electrode samples having a thickness of 21 μm to 237 μm, it can be determined that the discharging rate is more excellent in comparison to the electrode of the related art. With regard to a performance of the secondary battery, when considering that high-rate characteristics are important in an in-vehicle use, but in other uses, the electrode may be used even the C-rate is low, therefore even in a case of a thickness of 237 μm or greater, the electrode can function as an electrode.

Actually, even in a thickness of 1.2 mm, charging and discharging can be performed, and thus a function as a high-capacity battery was confirmed. However, in a thickness that is equal to or greater than this thickness, a lot of time is taken to manufacture an electrode sheet or the manufacturing cost increases, and thus the thickness is not realistic in consideration of a manufacturing process.

In addition, when the thickness of the electrode is less than 10 μm, in a case of manufacturing a sheet-shaped electrode, it is difficult to exhibit homogeneity or necessary mechanical strength, and thus requirements for the electrode sheet are not satisfied.

In addition, with regard to the performance of the secondary battery, when considering that high-rate characteristics are important in the in-vehicle use, but in other uses, the electrode may be used even the C-rate is relatively low, there is less of a problem for use in an electrode having a thickness of 1.2 mm.

Accordingly, it is possible to use the electrode in a thickness range of 10 μm to 1.2 mm, and it can be assumed that a range of 21 μm to 250 μm is more preferable from FIG. 13.

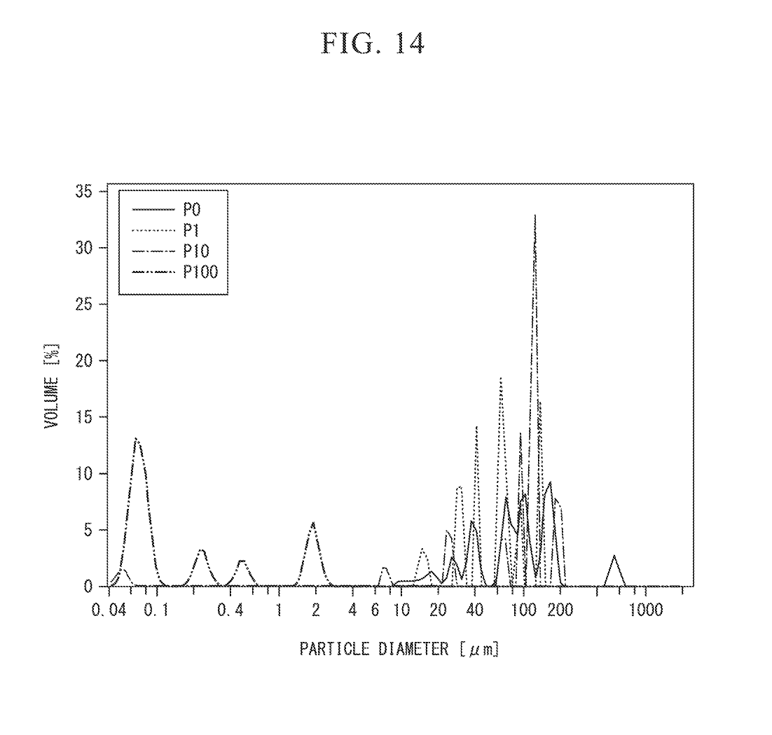

FIG. 14 shows particle size distribution measurement results which are obtained in accordance with the number of treatment times when manufacturing the above-described samples of Examples from Honda-MWNT by using the wet-type pulverizing apparatus NanoVater (registered trade mark: manufactured by Yoshida Kikai Co., Ltd.). A dispersion medium was obtained by adding 2.5 wt. % of a dispersing agent (lithium dodecyl sulfate (LDS)) to 1.332 mL of water, and the concentration of the carbon nano-tube was set to 0.02%.

In FIG. 14, P0 represents a particle size distribution of an electrode before treatment (the number of treatment times is 0 times). P1 represents a particle size distribution of a sheet-shaped electrode that is obtained at the number of treatment times of 1 time. P10 represents a particle size distribution of a sheet-shaped electrode at the number of treatment times of 10 times. P100 represents a particle size distribution of a sheet-shaped electrode that is obtained at the number of treatment times of 100 times. In addition, the sample after the number of treatment times of 100 times could not be shaped into a sheet shape, and a plurality of crushed pieces were obtained, and thus a particle size distribution of the crushed pieces (which corresponds to a length distribution of the carbon nano-tube) was measured.

When using the wet-type pulverizing apparatus NanoVater (registered trade mark: manufactured by Yoshida Kikai Co., Ltd.), it is possible to make the carbon nano-tube have a sheet shape while maintaining the particle size distribution of the carbon nano-tube due to shear force.

In the samples which have been treated for 1 time to 10 times, the carbon nano-tube having a particle size distribution of 6 μm to 200 μm can be shaped into a sheet shape.

In the samples which have been treated for 100 times, the average particle size can be set to 0.5 μm in a range of particle size distribution of 0.04 μm to 2.0 μm. However, the particle size distribution becomes too small, and thus it can be assumed that shaping into a sheet shape is difficult.

From results shown in FIG. 14, it can be seen that when the length of the carbon nano-tube that constitutes the skeleton fiber is set to 0.5 μm or greater, the three-dimensional fiber assembly of the carbon nano-tube can be formed in a sheet shape.

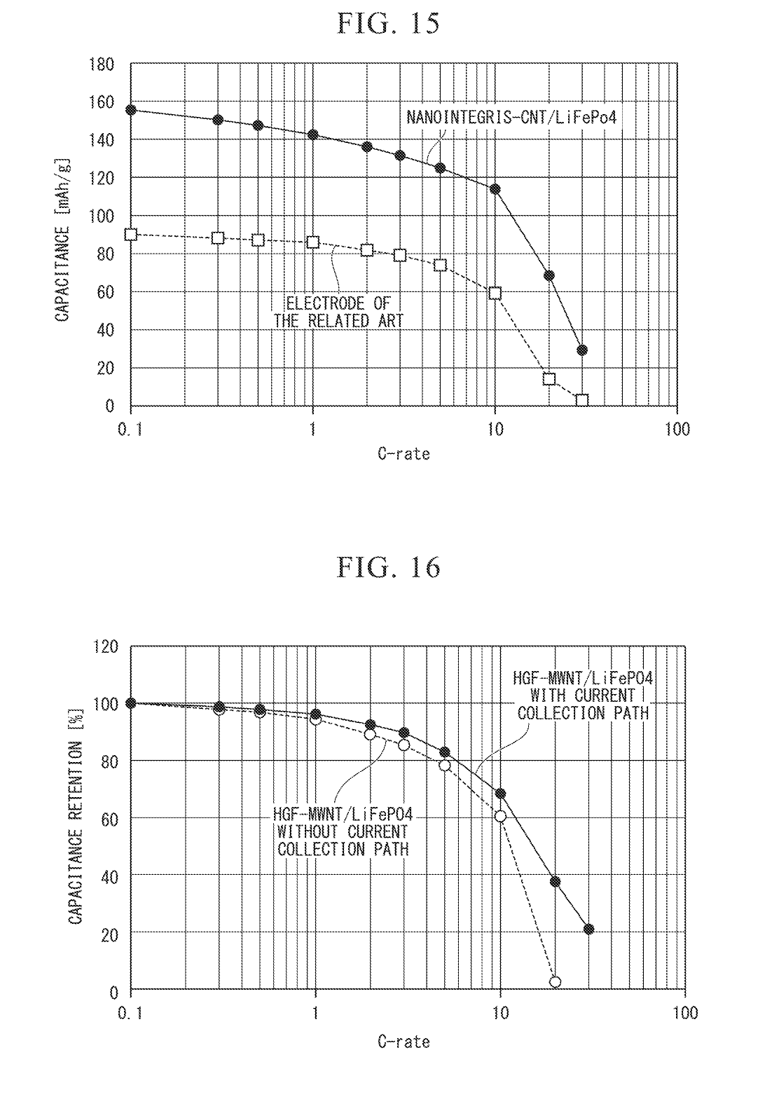

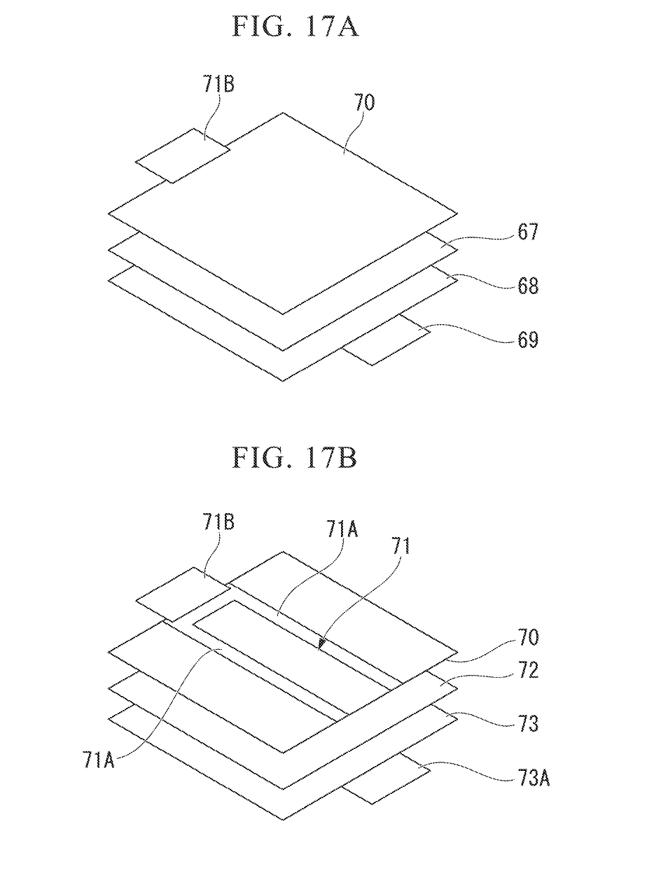

FIG. 15 shows a comparison result between a rate-evaluation result with a laminate half-cell and a rate-evaluation result with an electrode of the related art on the basis of weight of the current collector also serving as an electrode after manufacturing a current collector also serving as an electrode (3 cm×4 cm, refer to FIG. 17A) having the similar shape as in FIG. 2 by the same method as in Example 1 on the assumption of application to a laminated cell which is a laminated type as shown in FIGS. 3A and 3B. The weight ratio of the active material in a constituent member of the current collector also serving as an electrode which does not include a current collector was set to 85%. As the carbon nano-tube, SuperPlasma nanotube: C-SWNT manufactured by Nanointegris corporation (purity: 95% to 97%, diameter: 1.2 nm to 1.7 nm, and length: 300 nm to 5 μm) was used.

Even in the laminated cell as shown in FIG. 15, similar to the cell described with reference to FIG. 10, an improvement in capacity which corresponds to the weight of the current collector was recognized, an output and capacity, which were more excellent in comparison to the electrode of the related art, were confirmed due to a reduction in an internal resistance. Accordingly, the advantage of the current collector also serving as an electrode of the invention, that is, the electrode without a current collector was recognized.

FIG. 16 shows a comparison result of rate characteristics in terms of a capacity maintenance rate between a current collector also serving as an electrode which is the same as in FIG. 15 and has dimensions of 3 cm×4 cm, and a current collector also serving as an electrode according to the invention which is provided with a comb-like aluminum current collection path along a current extraction direction as shown in FIG. 17B, that is, an electrode without a current collector.

In a configuration shown in FIG. 17B, a current collection path 71 is configured in a comb-like shape by extending two conduction portions 71A, which have a width of 30 mm, a length of 45 mm, and a thickness of 0.02 mm and are provided along a current extraction direction of a current collector also serving as an electrode 70 with a gap of 5 mm therebetween, from an electrode tab portion 71B that is provided at the center on one side of the current collector also serving as an electrode 70. A separator 72 (Hipore: product name, manufactured by Asahi Kasei E-materials Corporation) and a negative electrode 73 formed from metal lithium were disposed on a rear surface side of the current collector also serving as an electrode 70, and a copper terminal portion 73A was provided on one side of the negative electrode 73. The weight ratio of the active material in constituent members of an electrode that does not include a current collector was set to 85%.

As shown in FIG. 17A, an electrode without a current collection path for comparison has the following configuration. A terminal portion 71B is provided at the center on one side of the current collector also serving as an electrode 70 which is the same as in FIG. 15 and has dimensions of 3 cm×4 cm, a separator 72 (Hipore: product name, manufactured by Asahi Kasei E-materials Corporation) and a negative electrode 73 formed from metal lithium were disposed on a rear surface side of the current collector also serving as an electrode 70, and a copper terminal portion 73A was provided on one side of the negative electrode 73.

Similar to the example, when the current path 71 as shown in FIG. 17B is appropriately provided along a current flowing direction, it is possible to further raise an output of a cell. However, in this case, the volume and the weight of the portion of the current collection path 71 are added, and thus an energy density slightly decreases in proportion to the addition. Accordingly, it is possible to provide an electrode optimal to a target cell at any time by determining whether or not to provide the current path 71, or by adjusting an area of the current path 71 in the case of providing the current path 71 with regard to cell requirements which are demanded.

In addition, the metal that constitutes the current collection path 71 is not limited to Al, and a metal material such as gold, which has satisfactory electrical conductivity and is electrochemically stable, may be used.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A current collector also serving as an electrode for a battery, comprising:
a three-dimensional fiber composite in which a plurality of conductors are disposed in a three-dimensional void of a three-dimensional fiber assembly skeleton, the three-dimensional fiber assembly skeleton being formed by intersecting and assembling a plurality of irregular shaped carbon nano-tubes,
wherein an active material that is carried on the carbon nano-tubes or on the conductors is accommodated in the three-dimensional void inside the three-dimensional fiber composite, and
the three-dimensional fiber composite is shaped in a sheet shape.

2. The current collector also serving as an electrode for a battery according to claim 1,
wherein the carbon nano-tubes and the conductors are contained in a total amount of 1% by mass to 95% by mass.

3. The current collector also serving as an electrode for a battery according to claim 2,
wherein the carbon nano-tubes and the conductors are contained in a total amount of 2% by mass to 75% by mass.

4. The current collector also serving as an electrode for a battery according to claim 1,
wherein a length of the carbon nano-tubes which constitute the three-dimensional fiber assembly skeleton is 0.5 μm to 2 mm,
each of the conductors is a carbon nano-tube, and
a length of the carbon nano-tube that constitutes the conductor is 0.01 μm to 2 mm, and sheet resistivity of the carbon nano-tube is 1×10⁻⁶ Ωcm to 0.56×10⁻¹ Ωcm.

5. The current collector also serving as an electrode for a battery according to claim 1,
wherein a pore size distribution of the three-dimensional void, which is formed in the three-dimensional fiber composite, has a peak at 2 nm to 1000 nm.

6. The current collector also serving as an electrode for a battery according to claim 1,
wherein a thickness of the current collector also serving as an electrode for a battery is 10 μm to 1.2 mm.

7. A battery, comprising:
the current collector also serving as an electrode for a battery according to claim 1.

8. The battery according to claim 7,
wherein a current collection path is disposed at a part of the current collector also serving as an electrode along a current extraction direction.
